(19) United States
(12) Patent Application Publication
(10) Pub. No.: US 2017/0094549 A1
(43) Pub. Date: Mar. 30, 2017

(54) Method and Node for Supporting Network Assisted Interference Cancellation

(71) Applicant: Telefonaktiebolaget LM Ericsson (publ), Stockholm (SE)

(72) Inventors: Sairamesh Nammi, Bedminster, NJ (US); Andres Reial, Malmö (SE); Yi-Pin Eric Wang, Fremont, CA (US)

(21) Appl. No.: 15/308,567

(22) PCT Filed: May 6, 2014
(86) PCT No.: PCT/SE2014/050553

§ 371 Date: Nov. 2, 2016

(51) Int. Cl. H04W 24/10; H04L 5/00

(52) U.S. Cl. CPC H04W 24/10; H04L 5/0032

(57) ABSTRACT

The present invention relates to a method for supporting network assistance interference cancellation at a first wireless device served by a first radio network node of a wireless communication network. A transmission of a second radio network node of the wireless communication network directed to a second wireless device interferes with a transmission of the first radio network node directed to the first wireless device. The method is performed in the second radio network node and comprises determining (610) whether to transmit network assistance information related to the transmission of the second radio network node to support interference cancellation at the first wireless device, and transmitting (620) the network assistance information to the first wireless device based on the determining.

### TECHNICAL FIELD

The disclosure relates to Network Assisted Interference Cancellation (NAIC), and more specifically to a radio network node and to a method performed in the radio network node for supporting NAIC.

### BACKGROUND

3rd Generation Partnership Project (3GPP) Long Term Evolution (LTE) is the fourth-generation mobile communication technologies standard developed within the 3GPP to improve the Universal Mobile Telecommunication System (UMTS) standard to cope with future requirements in terms of improved services such as higher data rates, improved efficiency, and lowered costs. The Universal Terrestrial Radio Access Network (UTRAN) is the radio access network of a UMTS and Evolved UTRAN (E-UTRAN) is the radio access network of an LTE system. In an UTRAN and an E-UTRAN, a User Equipment (UE) is wirelessly connected to a Radio Base Station (RBS) commonly referred to as a NodeB (NB) in UMTS, and as an evolved NodeB (eNodeB) in LTE. An RBS is a general term for a radio network node capable of transmitting radio signals to a UE and receiving signals transmitted by a UE.

The most common form of UMTS makes use of Wideband Code Division Multiple Access (WCDMA), which is an air interface standard that is a compulsory feature of any wireless device of the UTRAN. High Speed Downlink Packet Access (HSDPA) and High Speed Uplink Packet Access (HSUPA), together referred to as High Speed Packet Access (HSPA), are mobile communication protocols that were developed to cope with higher data rates than original WCDMA protocols were capable of.

FIG. 1a illustrates a radio access network with an RBS 101 that serves a UE 103 located within the RBS's geographical area of service, called a cell 105. In UMTS, a Radio Network Controller (RNC) 106 controls the RBS 101 and other neighboring RBSs, and is, among other things, in charge of management of radio resources in cells for which the RNC is responsible. The RNC is in turn also connected to the core network (not illustrated). FIG. 1b illustrates a radio access network in an LTE system. An eNodeB (eNB) 101a serves a UE 103 located within the RBS's geographical area of service or the cell 105a. The eNodeB 101a is directly connected to the core network (not illustrated). The eNodeB 101a is also connected via an X2 interface to a neighboring eNodeB 101b serving another cell 105b.

During the last few years, cellular operators have started to offer mobile broadband based on WCDMA/HSPA. Further, fuelled by new wireless devices designed for data applications, the end user performance requirements are steadily increasing. The large uptake of mobile broadband has resulted in that traffic volumes that need to be handled by the HSPA networks have grown significantly. Therefore, techniques that allow cellular operators to manage their spectrum resources more efficiently are of large importance.

Some techniques which make it possible to improve the downlink performance are 4-branch Multiple-Input-Multiple-Output (MIMO), multi-flow communication, and multi-carrier deployment. Since improvements in spectral efficiency per link are approaching theoretical limits, the next generation technology is about improving the spectral efficiency per unit area. In other words, the additional features for HSDPA need to provide a uniform user experience to users anywhere inside a cell by changing the topology of traditional networks. Currently 3GPP has been working on this aspect of using heterogeneous networks.

A homogeneous network is a network of radio network nodes, such as RBSs, NodeB, Remote Radio Heads (RRH), and Remote Radio Units (RRU), in a planned layout and a collection of user terminals. In the homogeneous network all radio network nodes have similar transmit power levels, antenna patterns, and receiver noise floors, as well as similar backhaul connectivity to the data network. In other words they are all belonging to a same base station power class. For example, all of them are either high power nodes (HPN) or low power nodes (LPN). An example of a HPN is a wide area RBS serving a macro cell. An example of a LPN is a local area RBS serving a pico cell. In other words a homogeneous network is a single tier system. Moreover, all RBSs offer unrestricted access to user terminals in the network, and serve roughly the same number of user terminals. Current wireless systems such as WCDMA, HSPA, and LTE fall under this category.

In heterogeneous networks several LPNs 202 such as micro, pico, femto, or relay base stations are deployed in addition to the planned or regular placement of HPNs 201 such as wide area RBSs serving macro cells 203, as shown in FIG. 2a. Therefore a heterogeneous network is at least a 2-tier system. Note that the power transmitted by these micro, pico, femto, or relay base stations is relatively small compared to that of macro base stations. A LPN may transmit at a power which can be up to 2 W, as compared to that of 40 W for macro base stations. The LPNs are often deployed to eliminate coverage holes in the homogeneous network. Hence they improve the capacity in hot-spots. Due to their lower transmit power and smaller physical size, LPNs can offer flexible site acquisitions.

The LPN cells in a cluster of heterogeneous nodes of a heterogeneous network may have different cell identifiers from that of HPN cells which means that they are viewed as different cells. Alternatively, they can have same cell identifiers as that of HPN cells. Such cells are sometimes referred to as soft, shared, or combined cells, or cluster with common cell identifiers.

FIG. 2b shows the heterogeneous network where LPNs 202 and HPNs 201 create separate cells 204 and 203 respectively, i.e. with different cell identifiers illustrated by the dotted cell 206 and 205 overlaid the illustration of the actual cell coverage 204 and 203. Simulations show that using LPNs in a macro cell offers load balancing, hence enabling large gains in system throughout as well as cell edge user throughput. One disadvantage with each cell creating a different cell is that a UE needs to do soft handover when moving from an LPN cell to a HPN cell or to another LPN cell. Hence higher layer signaling is needed to perform the handover.

FIG. 2c illustrates a heterogeneous network where LPN cells are part of the HPN cells, i.e. share cell identifier illustrated by the dotted cell 205 overlaid the illustration of the actual macro cell coverage 207. This set-up avoids frequent soft handovers and hence higher layer signaling. In the deployment of FIG. 2c, all the nodes are coupled to a central node, which in this case is a HPN 201. In a typical deployment scenario the LPNs are connected to a central controller via a high speed data link. The central controller in the combined cell takes responsibility for collecting operational statistics information of network environment measurements. The decision of what nodes that should transmit to a specific UE is made by the central controller, possibly based on information provided by the UE. The cooperation among various nodes is instructed by the central controller and implemented in a centralized way. The central controller is one of the network nodes, e.g. the HPN.

Even though large gains in terms of average sector throughput are achieved with the introduction of LPNs, the interference structure becomes more complex in heterogeneous networks. For example when a UE is served by an LPN, individual UE link throughput is impacted due to the interference caused by the HPN. FIG. 3a shows the link performance when a UE which is scheduled by an LPN experiences a strong interference from a HPN such as a macro RBS which is serving another UE. The interference due to other nodes than the interfering HPN is modeled as white noise. The diagram of FIG. 3a illustrates the performance degradation that occurs when the UE is in the vicinity of a strongly interfering HPN or macro node. In the diagram, the values for link throughput is plotted for different interference situations, given by an loc value that determines how strong the interfering signal from the macro node is compared to the signal strength from the serving cell. Ioc=0 dB means that the interfering signal is equal to the serving cell signal, and Ioc=20 dB means that the interfering signal is 20 dB stronger than the serving cell signal. The performance loss is in the range of 100% at high geometries, i.e. for the highest value of loc.

### Overview of Network Assisted Interference Cancellation (NAIC)

Range expansion is a technique in heterogeneous networks where user terminals are offloaded to LPNs even though they experience better downlink reception from the HPN or the macro RBS, thereby achieving load balancing gains. However, the performance of user terminals which are connected to LPNs is then impacted due to strong interference from the HPN. The HPN is in this case referred to as the aggressor node. It can be seen that significant performance gains can be achieved if the UE knows about signal format information of the interfering signals and thus can cancel the interference. This method is referred to as NAIC. FIG. 3b shows the link performance in terms of throughput when the network signals scheduling information for an interfering transmission from the aggressor HPN in accordance with a NAIC procedure. In the simulation behind the measurement results depicted in the diagram of FIG. 3b, the interfering signal is reconstructed at the UE receiver and the interference is then removed prior to detecting the serving cell signal. The macro node interference is in this example scenario 20 dB stronger than the LPN desired signal, i.e. Ioc=20 dB.

It can be seen from the diagram in FIG. 3b that the use of NAIC allows the interference to be significantly mitigated. This may be achieved with a serial interference cancelation receiver. Such a receiver may alternatively be referred to as an advanced receiver, an enhanced receiver, or an interference mitigation receiver.

In wireless communication systems supporting NAIC, the aggressor node may convey its scheduling information, also referred to as network assistance information, via a broadcast channel referred to as the network assisted control channel. The victim UE, i.e. the wireless device that is subject to the interference, uses this information to cancel the interference due to the aggressor nodes interfering transmission to another UE. Once the interfering signal is detected and reconstructed in the receiver of the victim UE, the interfering signal will be subtracted from the received signal, thereby reducing the interference caused by the aggressor node transmission.

For HSDPA, a transport layer channel, High-Speed Downlink Shared Channel (HS-DSCH), is implemented by three physical layer channels: High Speed-Shared Control Channel (HS-SCCH), Uplink High Speed-Dedicated Physical Control Channel (HS-DPCCH), and High Speed-Physical Downlink Shared Channel (HS-PDSCH). The HS-SCCH informs the UE that data will be sent on the HS-DSCH, 2 slots ahead. The HS-DPCCH carries acknowledgment information and current channel quality indicator (CQI). This is then used by the base station to calculate how much data to send to the UE on the next transmission. The HS-PDSCH is the channel to which the above HS-DSCH transport channel is mapped that carries actual user data. The Common Pilot Channel CPICH carries the broadcasted pilot signal identifying the NodeB cell. FIG. 4 is a signaling diagram illustrating the message sequence used for conveying the scheduling information or the network assistance information of the aggressor NodeB 402 to the wireless device 403 served by NodeB 401 in a HSPA network. The scheduling information may be conveyed by a common HS-SCCH order from the aggressor NodeB 402. Alternatively, the network assistance information may be conveyed through a broadcast channel. The channels conveying network assistance information such as the HS-SCCH may be referred to as network assisted control channels.

The network assisted control channel may contain either of the following network assistance information:
1. Scheduling information for the interfering downlink transmission by the aggressor node. In one solution, the HS-SCCH order consists of bits indicating that it is an order for informing about the scheduling information from the aggressor node. The scheduling information comprises modulation, transport block size information, and spreading codes, i.e orthogonal variable spreading factor (OVSF) codes used at the scheduling of the interfering transmission. The scheduling information may additionally comprise pre-coding and rank information when the aggressor node applies MIMO transmissions.
2. An identifier of the UE to which the aggressor node has scheduled a transmission that interferes with the LPN nodes transmission to the victim UE. In this case, the aggressor node conveys the identifier of a scheduled UE such that the victim UE can decode the HS-SCCH of the aggressor node directed to this UE and thereby retrieve the corresponding scheduling information of the interfering transmission.

The network assisted control channel requires a certain amount of power, typically −10 dB (i.e. 10%) of the total aggressor node power, to be allocated for the signaling of network assistance information. Hence, the power allocated for signaling increases. Since the total available transmit power in any node is constant, the power allocated for data transmission in the own cell decreases. This implies that the own cell throughput is reduced.

### SUMMARY

It is therefore an object to address some of the problems outlined above, and to provide a solution for reducing the power consumption for sending network assistance information used for NAIC. This object and others are achieved by the method and the radio network node according to the independent claims, and by the embodiments according to the dependent claims.

In accordance with a first aspect, a method for supporting network assistance interference cancellation at a first wireless device served by a first radio network node of a wireless communication network is provided. A transmission of a second radio network node of the wireless communication network directed to a second wireless device interferes with a transmission of the first radio network node directed to the first wireless device. The method is performed in the second radio network node and comprises determining whether to transmit network assistance information related to the transmission of the second radio network node to support interference cancellation at the first wireless device, and transmitting the network assistance information to the first wireless device based on the determining.

In accordance with a second aspect, a second radio network node for a wireless communication network configured to support network assisted interference cancellation at a first wireless device is provided. The first wireless device is served by a first radio network node of the wireless communication network. The second radio network node is configured to perform a transmission directed to a second wireless device, the transmission interfering with a transmission of the first radio network node directed to the first wireless device. The second radio network node is further configured to determine whether to transmit network assistance information related to the transmission of the second radio network node to support interference cancellation at the first wireless device. The second radio network node is also configured to transmit the network assistance information to the first wireless device based on the determining.

An advantage of embodiments is that unnecessary network assistance information signaling is avoided, thereby saving power which can be utilized for improving the own cell performance.

Other objects, advantages and features of embodiments will be explained in the following detailed description when considered in conjunction with the accompanying drawings and claims.

### BRIEF DESCRIPTION OF THE DRAWINGS

FIG. 1a is a schematic illustration of a WCDMA/HSPA radio network in which the present invention may be applied.

FIG. 1b is a schematic illustration of a UTRAN in which the present invention may be applied.

FIGS. 2a-c are block diagrams schematically illustrating example deployments of heterogeneous networks.

FIG. 3a is a diagram schematically illustrating the link throughput degradation for a victim UE due to aggressor node interference.

FIG. 3b is a diagram schematically illustrating link throughput improvement when using NAIC.

FIG. 4 is a signaling diagram illustrating the message sequences used for conveying network assistance information.

FIG. 5 is a schematic illustration of wireless devices with different geometry factors.

FIGS. 6a-d are flowcharts illustrating the method in the radio network node according to embodiments.

FIGS. 7a-b are block diagrams schematically illustrating the radio network node according to embodiments.

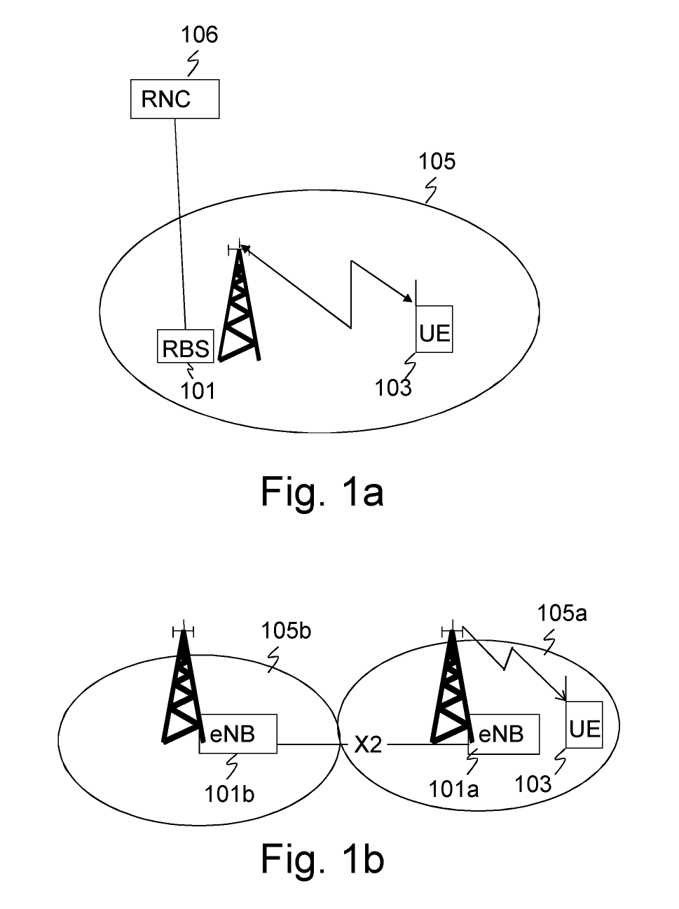

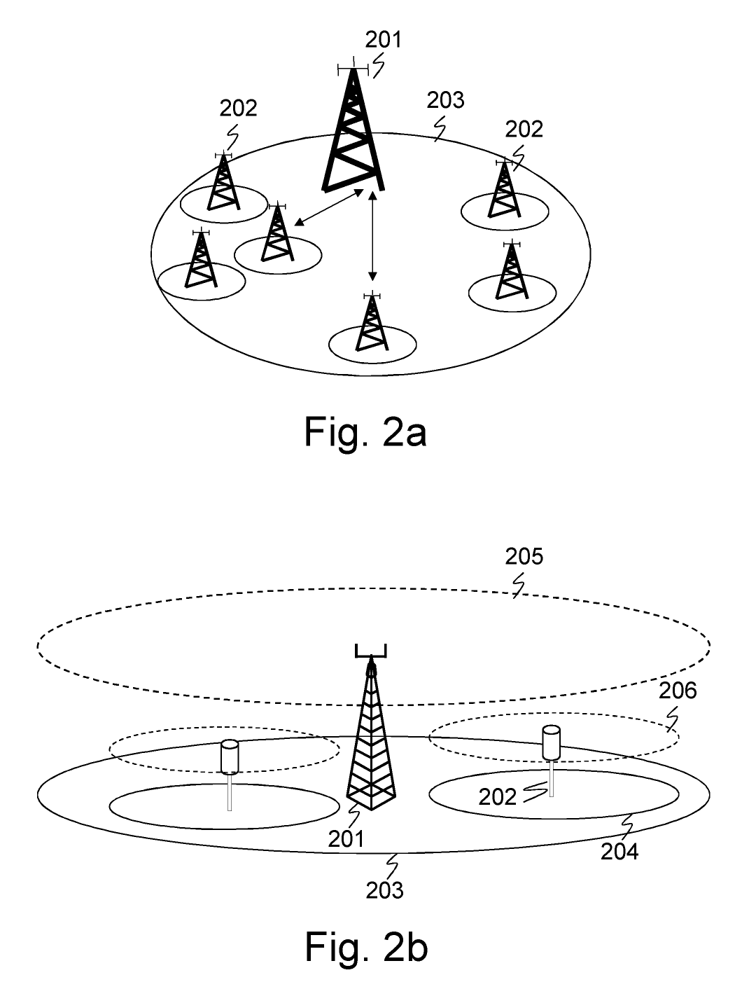

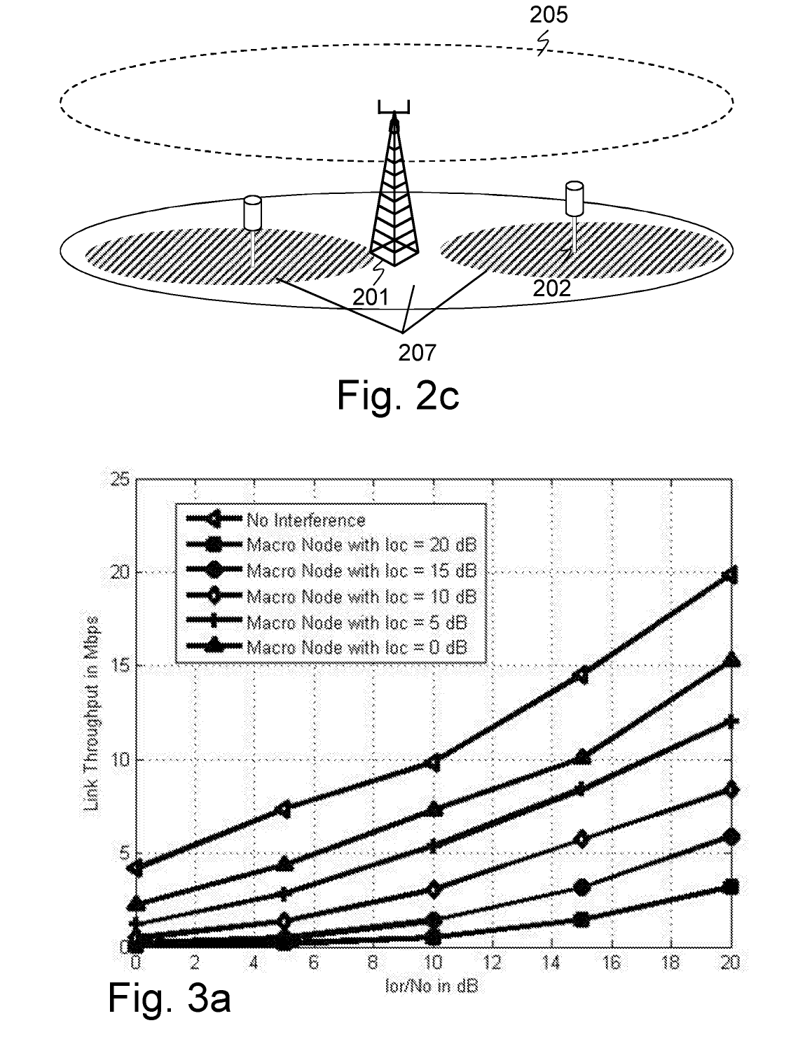

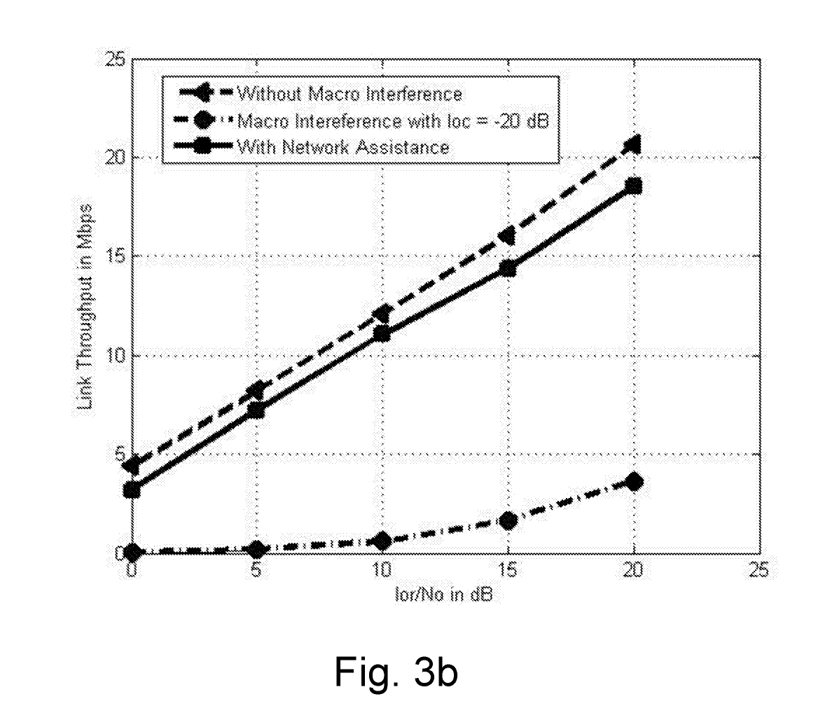

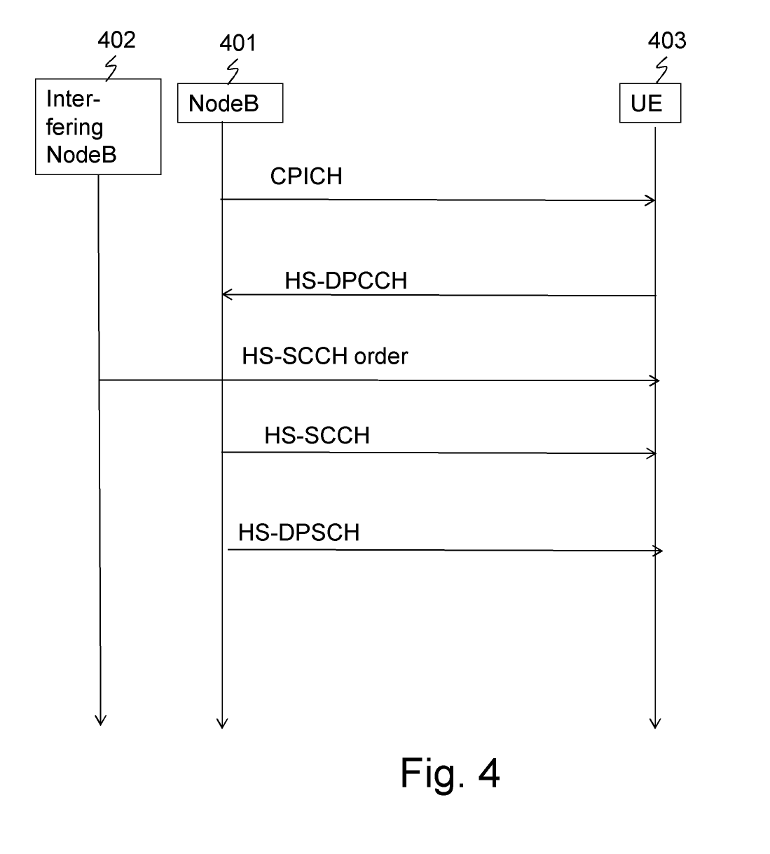

### DETAILED DESCRIPTION

In the following, different aspects will be described in more detail with references to certain embodiments and to accompanying drawings. For purposes of explanation and not limitation, specific details are set forth, such as particular scenarios and techniques, in order to provide a thorough understanding of the different embodiments. However, other embodiments that depart from these specific details may also exist.

Embodiments are described in a non-limiting general context in relation to an example scenario in a HSPA heterogeneous radio network, where an aggressor HPN transmission interferes with an LPN transmission to a wireless device. However, it should be noted that the embodiments may be applied to any network technology supporting NAIC such as the LTE technology. Furthermore, the network can be a homogeneous network deployment as well as any kind of heterogeneous network deployment where the downlink transmission of one node interferes with a downlink transmission of another node, such as any co-channel or combined cell deployment scenario.

In embodiments of the invention, the problem related to the signaling resource consumption for network assistance information signaling in a node supporting NAIC, is addressed by a solution where the power need is minimized by not transmitting the network assistance information at all times, but only when such transmission is deemed necessary. In this way the NAIC procedure applying signaling of e.g. scheduling information for the interfering transmission to the UE does not unduly deteriorate the own cell throughput performance.

NAIC is most effective if the victim UE is able to decode the data packet in the interfering transmission from the aggressor node scheduled to another UE. If the victim UE can't decode this packet, the gains of interference cancellation are usually smaller, in some cases even negligible. Hence when the victim UE cannot decode the aggressor node's transmission in current reception conditions, the power allocated to signaling over the network assisted control channel is typically wasted as there is no gain at system or link level. Therefore, it is preferable to switch off the network assisted control channel such that it isn't transmitting in such cases. The power allocated to the network assisted control channel may then be allocated to other channels. In one example scenario, the power can be allocated to data channels instead, thereby improving the throughput performance of the UE's in the aggressor cell as well as the overall system performance.

Hereinafter, different embodiments of how the aggressor node can decide whether to transmit the network assisted control channel or not are described. The decision of whether to transmit network assistance information is based on different criteria in the different embodiments.

### EMBODIMENT A

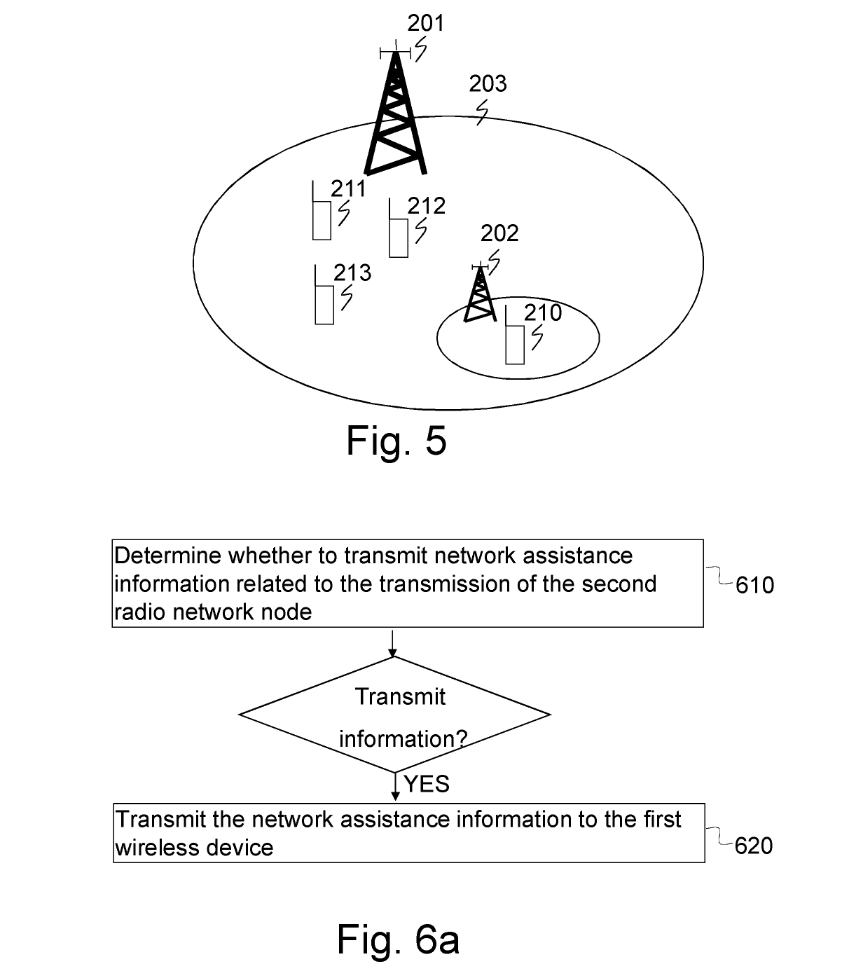

In a first embodiment A, the decision of whether to transmit network assistance information is an autonomous decision by the aggressor node. The decision is based on the geometry aspects of the UE in the cell served by the aggressor node. The aggressor node determines to not transmit network assistance information on the network assisted control channel if the geometry factor of the UE it is serving is greater than a pre-configured threshold G_Th. The reason is that if the aggressor node is serving a UE with a high geometry factor, meaning that the UE is close to the aggressor node, then the UE in the cell of the victim LPN, which is typically at or beyond the cell edge of the cell served by the aggressor node, usually cannot fully decode the data packet intended for the UE in the aggressor cell. By fully decode we here mean that the information bits can be detected with no error as indicated by, e.g., a Cyclic Redundancy Check (CRC). This is further explained with reference to FIG. 5. The aggressor HPN 201 is serving UE's 211, 212, and 213 at different locations, and the LPN 202 is serving a UE 210. If G_Th is chosen such that only 211 and 212 are considered as high geometry UEs and if the aggressor HPN 201 is serving these UEs in any Transmission Time Interval (TTI), then the network assisted control channel can be switched off.

There are several different possible techniques for computing the geometry of the UE served by the HPN in the cell. One example is to determine the geometry based on CQI reports from the UE. In HSDPA and in LTE, the UE reports a periodic or an aperiodic CQI determined based on UE measurements of the pilot or reference signal transmitted by the serving node. The NodeB/eNodeB can determine the geometry factor of the UE by averaging the CQI reports over time. Alternatively, the NodeB/eNodeB can determine the geometry factor of the UE from the UE's downlink mobility measurement reports.

Another example is to determine the geometry based on uplink measurements performed by the aggressor node. From the uplink measurements, such as UE traffic channel or control channel measurements, the geometry factor of the UE may be determined based on the uplink received signal strength.

### EMBODIMENT B

In a second embodiment B, the decision of whether to transmit network assistance information is also an autonomous decision by the aggressor node. The decision is based on the aggressor node's scheduling parameters used for the transmission to the UE in the serving cell of the aggressor node. This embodiment is similar to embodiment A, however, instead of finding the geometry of the currently served UE, the aggressor node bases it decision to transmit the network assisted control channel on the scheduling parameters for that UE. In analogy with the case of a UE with a high geometry factor, a UE which is allocated a less robust modulation and coding by the aggressor node means that it is unlikely that the victim UE can fully decode the data packet transmitted by the aggressor node to this UE. The decision could also be based on instantaneous or recent CQI values reported by the served UE, since the scheduled rate is closely related to the received CQI reports.

In embodiment B, the decision to transmit the assistance information will provide a more instantaneous optimization, in contrast to the embodiment A where the geometry factor is a long-term parameter.

In one example of embodiment B, the aggressor node assigns a certain modulation scheme and a certain transport block size in the i:th TTI. This means that the aggressor node assigns a number of bits equal to Mi, and a code rate equal to Ri. The aggressor node may then determine that the network assisted control channel is transmitted only when f(Mi*RI)<M_Th, where M_Th is a preconfigured threshold. In another example of embodiment B, the aggressor node can compute Mi*Ri over a period of time for a UE and decide not to transmit the network assisted control channel for the UE if the UE's scheduling factor (SF) is greater than a preconfigured threshold, where the scheduling factor is defined as

$$SF = {\sum }_{i = 1}^{N} MiRi / N$$

where N is the number of scheduled TTIs observed.

### EMBODIMENT C

In a third embodiment C, the decision whether to transmit network assistance information is a decision by the aggressor node based on knowledge about scheduling parameters and interference cancellation (IC) gains at the victim UE. In a UE applying soft IC, which may be either pre-decoding IC or post-decoding IC, the metric which is important for this embodiment is the difference between pre-decoding IC and post-decoding IC gain. To obtain significant post-decoding IC gains, it is not necessary to fully decode the packet. Even when the Signal to Interference plus Noise Ratio (SINR) is lower than that required for full decoding, the victim UE may be able to achieve high cancellation efficiencies, especially for high code rates. However, when the SINR gap exceeds a certain threshold which is transport format specific, post-decoding IC gains become negligible. As pre-decoding IC is typically possible without network assistance information while post-decoding IC requires network assistance information, the aggressor cell should only transmit the network assistance information over the network assisted control channel when post-decoding gains are likely to be higher than pre-decoding gains.

In one example embodiment, the aggressor node determines the transport format for the currently scheduled UE based on the scheduling parameters. Furthermore, the aggressor node evaluates the expected post-decoding IC gains over pre-decoding IC for that transport format and at geometries that are typical for the victim UE. The expected gains may be expressed as an improvement of cancellation efficiency, e.g. using a pre-computed look-up table, or as an improvement of SINR after IC. The aggressor node then decides to transmit the network assisted control channel if the expected gains exceed a threshold.

### EMBODIMENT D

In a fourth embodiment D, the decision of whether to transmit network assistance information is a decision by the aggressor node made with assistance information from the victim LPN. In one example embodiment, the LPN serving the victim UE shares its scheduling information on a TTI level with the aggressor node through a high speed link. The aggressor node may then decide not to transmit the network assisted control channel if the scheduling information from the LPN indicates the victim UE would need a more robust coding or lower scheduling factor than those corresponding to the scheduling information used by the aggressor node.

### EMBODIMENT E

In a fifth example embodiment E, the LPN serving the victim UE explicitly indicates to the aggressor node not to transmit the network assisted control channel. This may be used when the victim UE is close to the LPN. Another example is when there are no UEs in the victim cell that can benefit from the network assisted control channel, a decision made by the LPN based e.g. on a UE category or capability.

### EMBODIMENT F

In a sixth embodiment F, the decision of whether to transmit network assistance information is a decision by the aggressor node made with assistance information from an RNC. The RNC regulates the offloading factor by setting the cell selection offset parameters, e.g. the cell individual offset (CIO) as defined in the 3GPP specifications. When a HPN cell is overloaded, the RNC can use CIO to increase offloading from the HPN cell to LPN cells. Thus, the aggressor HPN can learn from the RNC about the CIO settings. If the CIO setting indicates that no aggressive off-loading of the HPN is applied, it may mean that no UE's will be in the LPN range expansion area. The aggressor HPN may then decide not to transmit the network assisted control channel.

### Method and Radio Network Node

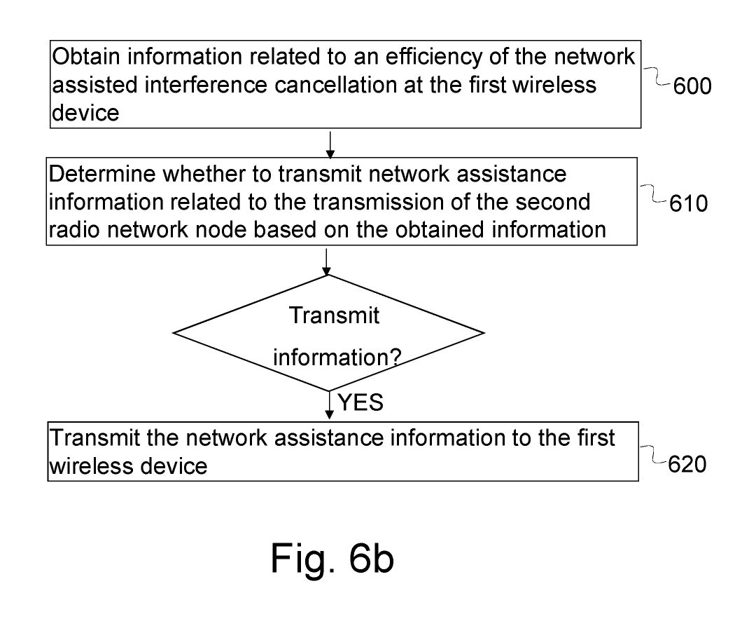

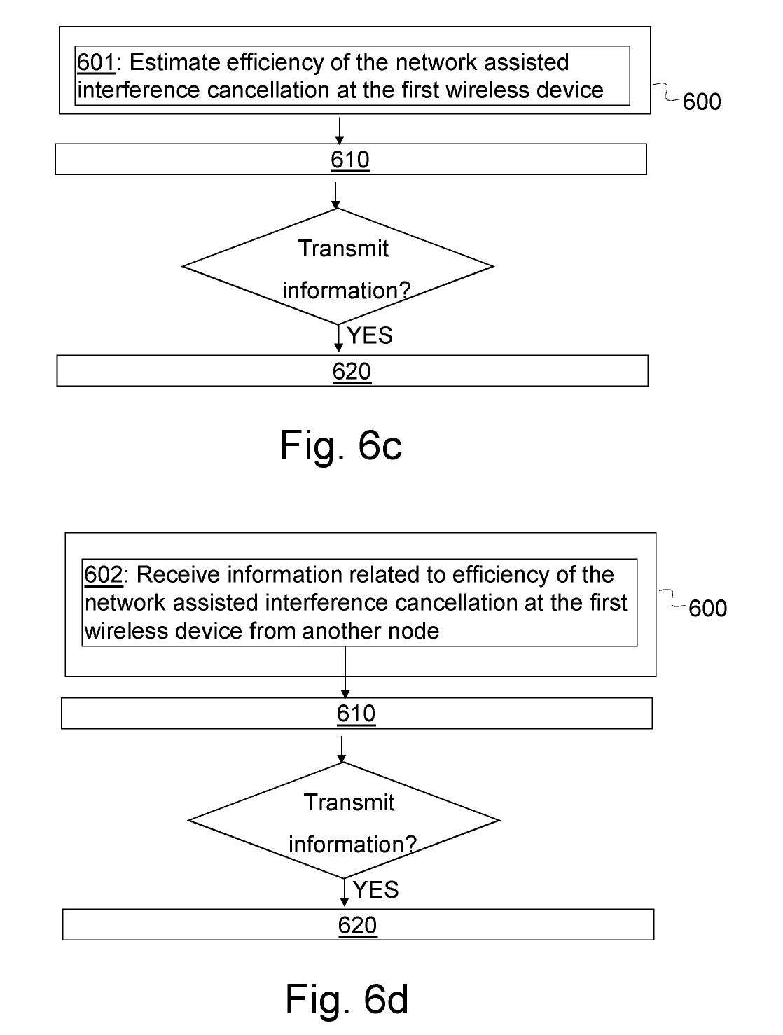

FIG. 6a is a flowchart illustrating one embodiment of a method for supporting network assistance interference cancellation at a first wireless device 730 served by a first radio network node 740 of a wireless communication network. A transmission of a second radio network node 720 of the wireless communication network directed to a second wireless device 710 interferes with a transmission of the first radio network node directed to the first wireless device. The method is performed in the second radio network node 720 and comprises:
610: Determining whether to transmit network assistance information related to the transmission of the second radio network node to support interference cancellation at the first wireless device.
620: Transmitting the network assistance information to the first wireless device based on the determining. The network assistance information is transmitted to the first wireless device when it is determined to transmit.

FIG. 6b is a flowchart illustrating another embodiment of the method. The method optionally comprises:
600: Obtaining information related to an efficiency of the network assisted interference cancellation at the first wireless device.

The method also comprises:
610: Determining whether to transmit network assistance information related to the transmission of the second radio network node to support interference cancellation at the first wireless device, wherein the determining is based on the obtained information
620: Transmitting the network assistance information to the first wireless device based on the determining.

FIG. 6c is a flowchart illustrating an embodiment of the method described with reference to FIG. 6b. Obtaining 600 information related to the efficiency of the network assisted interference cancellation at the first wireless device comprises estimating 601 an efficiency of the network assisted interference cancellation at the first wireless device. In 610 it is thus determined to transmit the network assistance information based on the estimated efficiency.

In one embodiment, estimating 601 the efficiency of the network assisted interference cancellation at the wireless device may comprise determining a geometry factor of the second wireless device, and estimating that the network assisted interference cancellation at the first wireless device is efficient if the geometry factor is lower than a first threshold. One example embodiment is embodiment A described previously. The geometry factor may be determined based on at least one of channel quality measurement reports received from the second wireless device, signal quality measurement reports received from the second wireless device, and uplink measurements on channels of the second wireless device.

In another embodiment, the efficiency may be estimated 601 based on scheduling parameters used for the transmission of the second radio network node directed to the second wireless device. One example embodiment is embodiment B described previously.

In still another embodiment, estimating 601 the efficiency of the network assisted interference cancellation at the wireless device may comprise determining a gain for post-decoding interference cancellation over pre-decoding interference cancellation at the first wireless device, and estimating that the network assisted interference cancellation at the first wireless device is efficient if the gain for post-decoding interference cancellation over pre-decoding interference cancellation exceeds a second threshold. One example embodiment is embodiment C described previously.

FIG. 6d is a flowchart illustrating an alternative embodiment to the method described with reference to FIG. 6c. In this embodiment, obtaining 600 information related to the efficiency of the network assisted interference cancellation at the first wireless device, may comprise receiving 602 the information related to the efficiency of the network assisted interference cancellation at the first wireless device from another node. In one embodiment, the information related to the efficiency of the network assisted interference cancellation at the first wireless device may be received 602 from the first radio network node and may comprise scheduling parameters used for the transmission of the first radio network node directed to the first wireless device. The determining 610 may thus comprise comparing scheduling parameters used for the transmission of the second radio network node directed to the second wireless device with the received scheduling parameters used for the transmission of the first radio network node directed to the first wireless device, and determining to transmit the network assistance information based on the comparison. One example embodiment is embodiment D described previously.

In another embodiment, the information related to the efficiency of the network assisted interference cancellation at the first wireless device may be received 602 from the first radio network node, and indicates to the second radio network node not to transmit the network assistance information. One example embodiment is embodiment E described previously.

In a further embodiment, the information related to the efficiency of the network assisted interference cancellation at the first wireless device may be received 602 from an RNC controlling the first and the second radio network node. The information may comprise a level of off-loading indicating to what extent the second radio network node is offloaded by the first radio network node. It may be determined 610 to transmit the network assistance information if the level of off-loading exceeds a third threshold. One example embodiment is embodiment F described previously.

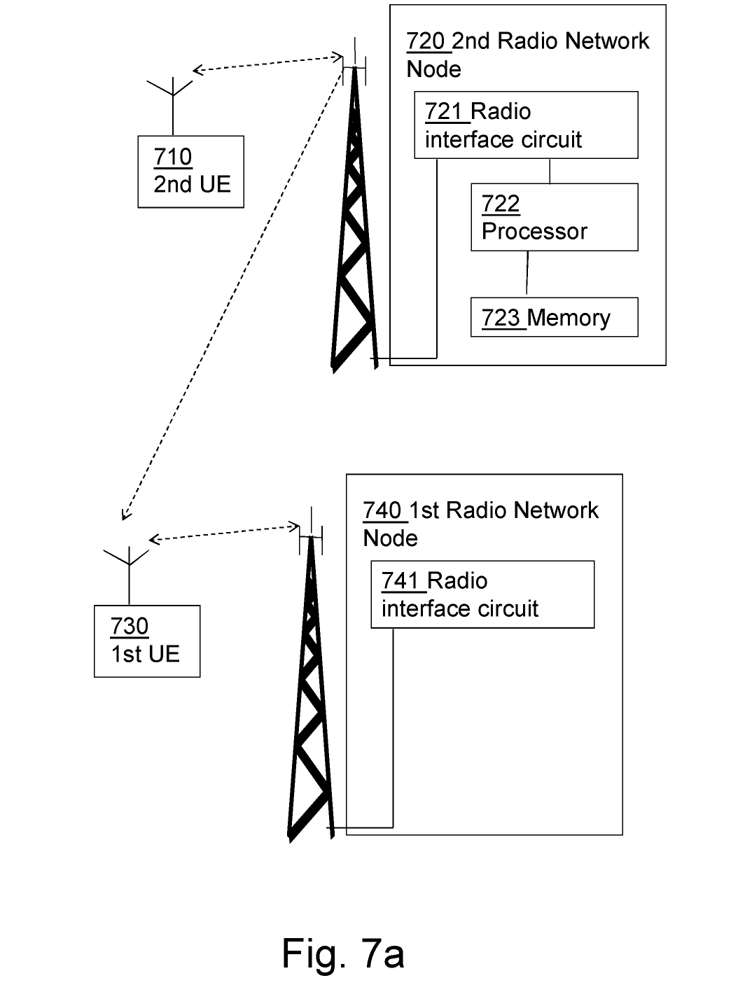

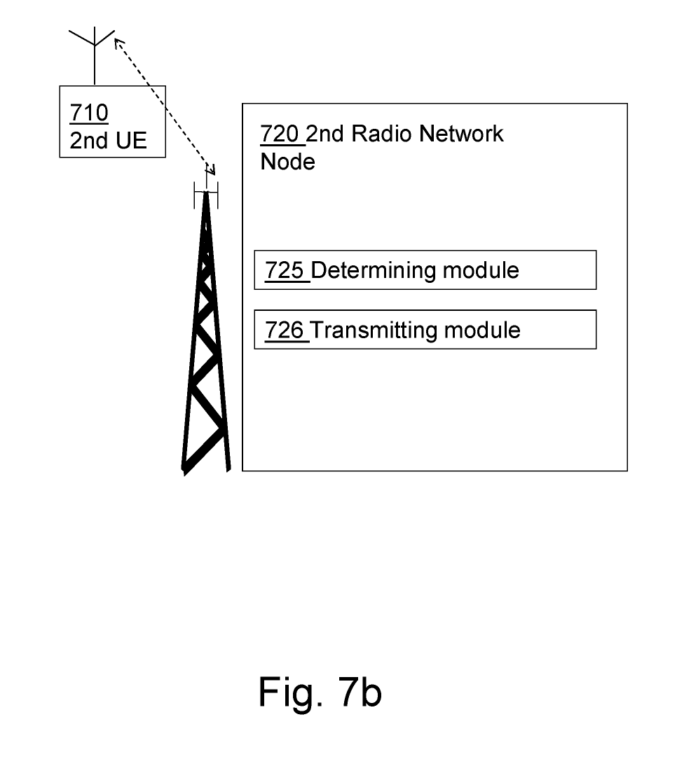

An embodiment of a second radio network node 720 for a wireless communication network is schematically illustrated in the block diagram in FIG. 7a. The second radio network node 720 is configured to support network assisted interference cancellation at a first wireless device 730 served by a first radio network node 740 of the wireless communication network. The second radio network node 720 is configured to perform a transmission directed to a second wireless device 710, the transmission interfering with a transmission of the first radio network node 740 directed to the first wireless device 730. The second radio network node 720 is configured to determine whether to transmit network assistance information related to the transmission of the second radio network node to support interference cancellation at the first wireless device. The second radio network node 720 is also configured to transmit the network assistance information to the first wireless device based on the determining. The first and the second radio network nodes may be NodeBs in a UTRAN, and the first and second wireless devices may be UEs.

In one embodiment, the second radio network node 720 may be further configured to obtain information related to an efficiency of the network assisted interference cancellation at the first wireless device, and to determine whether to transmit the network assistance information based on the obtained information.

In a further embodiment, the second radio network node 720 may be further configured to obtain information related to the efficiency of the network assisted interference cancellation at the first wireless device by estimating an efficiency of the network assisted interference cancellation at the first wireless device. The second radio network node 720 may be further configured to determine to transmit the network assistance information based on the estimated efficiency. In still another embodiment, the second radio network node 720 may be further configured to estimate the efficiency of the network assisted interference cancellation at the wireless device by determining a geometry factor of the second wireless device, and estimating that the network assisted interference cancellation at the first wireless device is efficient if the geometry factor is lower than a first threshold. In one embodiment, the second radio network node 720 may be further configured to determine the geometry factor based on at least one of channel quality measurement reports received from the second wireless device, signal quality measurement reports received from the second wireless device, and uplink measurements on channels of the second wireless device.

In another embodiment, the second radio network node 720 may be further configured to estimate the efficiency of the network assisted interference cancellation at the wireless device based on scheduling parameters used for the transmission of the second radio network node directed to the second wireless device.

In one embodiment, the second radio network node 720 may be further configured to estimate the efficiency of the network assisted interference cancellation at the wireless device by determining a gain for post-decoding interference cancellation over pre-decoding interference cancellation at the first wireless device, and estimating that the network assisted interference cancellation at the first wireless device is efficient if the gain for post-decoding interference cancellation over pre-decoding interference cancellation exceeds a second threshold.

In another embodiment, the second radio network node 720 may be further configured to obtain information related to the efficiency of the network assisted interference cancellation at the first wireless device by receiving the information related to the efficiency of the network assisted interference cancellation at the first wireless device from another node. In one embodiment, the second radio network node 720 may be further configured to receive the information related to the efficiency of the network assisted interference cancellation at the first wireless device from the first radio network node. The received information may comprise scheduling parameters used for the transmission of the first radio network node directed to the first wireless device. The second radio network node 720 may be further configured to compare scheduling parameters used for the transmission of the second radio network node directed to the second wireless device with the received scheduling parameters used for the transmission of the first radio network node directed to the first wireless device, and to determine to transmit the network assistance information based on the comparison. In another embodiment, the second radio network node 720 may be further configured to receive the information related to the efficiency of the network assisted interference cancellation at the first wireless device from the first radio network node, the received information indicating to the second radio network node not to transmit the network assistance information. In still another embodiment, the second radio network node 720 may be further configured to receive the information related to the efficiency of the network assisted interference cancellation at the first wireless device from an RNC controlling the first and the second radio network node. The received information may comprise a level of off-loading indicating to what extent the second radio network node is offloaded by the first radio network node. The second radio network node 720 may be further configured to determine to transmit the network assistance information if the level of off-loading exceeds a third threshold.

In embodiments of the invention, the second radio network node 720 may comprise a processor 722 and a memory 723. The second radio network node 720 may also comprise a radio interface circuit 721 configured to communicate with the second wireless device 710, and connected to the processor 722. The memory 723 may comprise instructions executable by the processor 722. The second radio network node 720 may thereby be operative to determine whether to transmit network assistance information related to the transmission of the second radio network node to support interference cancellation at the first wireless device. The second radio network node 720 may also be operative to transmit the network assistance information to the first wireless device based on the determining. In one embodiment, the second radio network node 720 may be operative to obtain information related to an efficiency of the network assisted interference cancellation at the first wireless device, and to determine whether to transmit the network assistance information based on the obtained information. The first radio network node 740 of the wireless communication network, also illustrated in FIG. 7b, may also comprise a radio interface circuit 741 for the communication with the first wireless device.

In an alternative way to describe the embodiment in FIG. 7a, illustrated in FIG. 7b, the second radio network node 720 comprises a determining module 725 adapted to determine whether to transmit network assistance information related to the transmission of the second radio network node to support interference cancellation at the first wireless device, and a transmitting module 726 adapted to transmit the network assistance information to the first wireless device 710 based on the determining. The modules described above are functional units which may be implemented in hardware, software, firmware or any combination thereof. In one embodiment, the modules are implemented as a computer program running on a processor.

In an alternative way to describe the embodiment in FIG. 7a, the second radio network node 720 comprises a Central Processing Unit (CPU) which may be a single unit or a plurality of units. Furthermore, second radio network node 720 comprises at least one computer program product (CPP) in the form of a non-volatile memory, e.g. an EEPROM (Electrically Erasable Programmable Read-Only Memory), a flash memory or a disk drive. The CPP comprises a computer program, which comprises code means which when run on the second radio network node 720 causes the CPU to perform steps of the procedure described earlier in conjunction with FIGS. 6a-d. In other words, when said code means are run on the CPU, they correspond to the processor 722 of FIG. 7a.

The above mentioned and described embodiments are only given as examples and should not be limiting. Other solutions, uses, objectives, and functions within the scope of the accompanying patent claims may be possible.

1-23. (canceled)

24. A method for supporting network assistance interference cancellation at a first wireless device served by a first radio network node of a wireless communication network, wherein a transmission of a second radio network node of the wireless communication network directed to a second wireless device interferes with a transmission of the first radio network node directed to the first wireless device, the method being performed in the second radio network node and comprising:
determining whether to transmit network assistance information related to the transmission of the second radio network node to support interference cancellation at the first wireless device; and
transmitting the network assistance information to the first wireless device based on the determining.

25. The method according to claim 24, further comprising:
obtaining information related to an efficiency of the network assisted interference cancellation at the first wireless device; and
wherein the determining is based on the obtained information.

26. The method according to claim 25, wherein obtaining information related to the efficiency of the network assisted interference cancellation at the first wireless device comprises
estimating an efficiency of the network assisted interference cancellation at the first wireless device, and
wherein the determining to transmit the network assistance information is based on the estimated efficiency.

27. A second radio network node for a wireless communication network configured to support network assisted interference cancellation at a first wireless device served by a first radio network node of the wireless communication network, wherein the second radio network node is configured to perform a transmission directed to a second wireless device, the transmission interfering with a transmission of the first radio network node directed to the first wireless device, the second radio network node comprising:
radio circuitry configured for communication with the first and second wireless devices; and
processing circuitry operatively associated with the radio circuitry and configured to:
determine whether to transmit network assistance information related to the transmission of the second radio network node to support interference cancellation at the first wireless device; and
transmit the network assistance information to the first wireless device based on the determining.

28. The second radio network node according to claim 27, wherein the processing circuitry is configured to:
obtain information related to an efficiency of the network assisted interference cancellation at the first wireless device; and
determine whether to transmit the network assistance information based on the obtained information.

29. The second radio network node according to claim 28, wherein the processing circuitry is configured to:
obtain information related to the efficiency of the network assisted interference cancellation at the first wireless device by estimating an efficiency of the network assisted interference cancellation at the first wireless device; and
determine to transmit the network assistance information based on the estimated efficiency.
